(19) United States
(12) Patent Application Publication
(10) Pub. No.: US 2008/0265776 A1
(43) Pub. Date: Oct. 30, 2008

(54) Light Source and Assembly of Light Sources

(75) Inventor: Maarten Robert Wirtz, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/090,880

(22) PCT Filed: Oct. 12, 2006
(86) PCT No.: PCT/IB2006/053753

§ 371 Date: Apr. 21, 2008

(30) Foreign Application Priority Data
Oct. 20, 2005 (EP) 05109767.3

(51) Int. Cl. H01J 61/02; H01J 5/48

(52) U.S. Cl. 313/634; 313/318.02

(57) ABSTRACT

The invention relates to a light source comprising: an at least partly light-transmitting elongate discharge vessel filled with an ionizable substance, at least one first electrode and at least one second electrode connected to respective end portions of the light source, between which first and second electrodes a discharge extends during lamp operation, at least one electrode of the first electrode and the second electrode extending laterally with respect to the corresponding end portion. The invention also relates to an assembly of light sources according to the invention.

The invention relates to a light source comprising: an at least partly light-transmitting elongate discharge vessel filled with an ionizable substance, a first electrode and a second electrode connected to respective end portions of the light source, between which first and second electrodes a discharge extends during lamp operation, at least one electrode of the first electrode and the second electrode thereby extending laterally with respect to the corresponding end portion. The invention also relates to an assembly of light sources according to the invention.

It is known that display devices, such as LCD picture screens, commonly require a backlighting of their entire surface area which is as homogeneous as possible for rendering a picture visible. Lamps according to the preamble are frequently used for this purpose, wherein both electrodes extend laterally with respect to the end portions of the lamp. It is a problem with this type of lamps that their packing density is relatively poor, in particular during storage and transport of these lamps, due to the laterally extending electrodes which require a considerably distance between the lamps. This results in a relatively voluminous and hence inefficient packing of the lamps, wherein a relatively large space is left unused. This voluminous packing of the known light sources commonly leads to substantial expenses for transport and storage of these light sources.

It is an object of the invention to provide an improved light source with which an improved packing density can be realized.

This object can be achieved by providing a light source according to the preamble, characterized in that at least one end portion is provided with at least one receiving slot for receiving at least a portion of at least one electrode of at least one other, similar light source. The provision of one or more receiving slots in one or more end portions of the light source means that multiple (substantially) similar light sources can be stacked in a relatively compact manner, since a certain overlap is generated between neighboring (cooperating) light sources. Consequently, the open space between the light sources is substantially reduced, which will result in significant cost savings for transport and storage of the light sources according to the invention. Depending on the design of the light sources and on the dimensioning and geometry of both the electrodes and the receiving slot(s), a volume reduction of about 40 percents can be obtained. Moreover, since the light sources according to the invention can be packed in a relatively efficient manner, a protective casing for packing the assembly of light sources can be of a less complex design, so that the amount of packing material can also be reduced, leading to further reductions in the cost price of the casing.

In a preferred embodiment, each end portion of the light source is connected to an electrode comprising multiple contact elements that extend laterally with respect to said end portion. Each end portion is preferably provided with at least one receiving slot so as to be able to accommodate portions of each electrode within a receiving slot. A receiving slot of an end portion of the light source may be a shared receiving slot and may accordingly be adapted for simultaneously receiving multiple contact elements at least partly. In a preferred embodiment, however, at least one, and preferably each, end portion of the light source is provided with multiple receiving slots for receiving a corresponding number of contact elements. In this embodiment, each contact element can be received by a specific receiving slot. It is noted in this context that the receiving slot is defined by an end portion of the light source. Commonly, this receiving slot can be accessed from multiple directions, the receiving slot being often formed by a stacking recess. However, those skilled in the art will readily appreciate that the receiving slot may alternatively be formed by a cavity made in the end portion, which cavity may be provided with a feed-through aperture so as to render the cavity accessible from a single, predetermined direction only.

The discharge vessel to be applied in the light source according to the invention is commonly made of thin-walled glass. To protect the relatively fragile discharge vessel, protective end caps are commonly applied, said end caps being connected to the extremities of the discharge vessel. These end caps are commonly made of plastic. It is unlikely in practice that each receiving slot is defined by a portion of the thin-walled glass vessel, since the vessel will be damaged relatively easily upon contact with an electrode. For this reason, each protective end cap is preferably provided with one or more receiving slots. In a preferred embodiment, each end cap is provided with at least one laterally projecting element, said projecting element being adapted to cooperate with an end cap of another, similar light source for substantially spacing the discharge vessels of the two light sources apart so as to prevent, or at least counteract, physical contacts between neighboring discharge vessels, which would easily damage each vessel. In a more preferred embodiment, the projecting element is adapted to be detachably coupled to an end cap of another, similar light source. In this manner, the mutual orientation of the stacked (nested) light sources can be substantially fixed, as a result of which the risk of accidental damage of the discharge vessels caused by mutual contact of these vessels can be minimized. Another way to prevent the discharge vessels making physical contact during stacking of the light sources according to the invention is to reduce the depth of the receiving slot, as a result of which a smaller portion of the electrode can be accommodated by the receiving slot. A mutual coupling of end caps of multiple, similar light sources to secure a stable and safe packing of the light sources can be realized in various different ways. For example, it is conceivable that an end cap of a light source can be coupled to one or more electrodes and/or an end cap of another, similar light source, for example, a (detachable) snap connection being formed between the light sources. Preferably, however, coupling is realized by mutual clamping of parts of neighboring light sources. To this end, it is preferable that at least a portion of each end cap is made of a flexible material, in particular an elastomer. In this manner each receiving slot may be adapted to engage at least one electrode of another, similar light source with clamping fit to secure a reliable coupling between the light sources. However, making at least a portion of the end cap of an elastomer also has another major advantage. The use of a flexible material in the end cap, or at least a portion thereof, generates a certain absorbing or buffering capacity of the end cap, as a result of which an assembly of stacked light sources according to the invention is given a certain capacity to resist impacts. The failure rate of the assembly of light source during transport and storage can thus be minimized.

In a preferred embodiment, each receiving slot is adapted for substantially enclosing an outwardly extending portion of an electrode of another, similar light source. The electrode can be protected during transport and storage in that the free contact element(s) of the electrode is (are) surrounded, whereby damage to the electrode can be prevented or at least counteracted.

The invention also relates to an assembly of multiple light sources according to the invention, wherein the electrodes of each light sources are partly received by the receiving slots of a neighboring light source. The stack orientation of the assembly of light sources will be predetermined, but may be of various kinds. In a preferred embodiment, the assembly of light sources is oriented substantially linearly. A column of stacked light sources can thus be generated. In an alternative embodiment, the assembly of light sources is oriented substantially non-linearly, wherein the assembly of light sources may be stacked, for example, in a serpentine-like orientation.

The invention will be further illustrated with reference to the following non-limitative embodiments and the drawing, wherein:

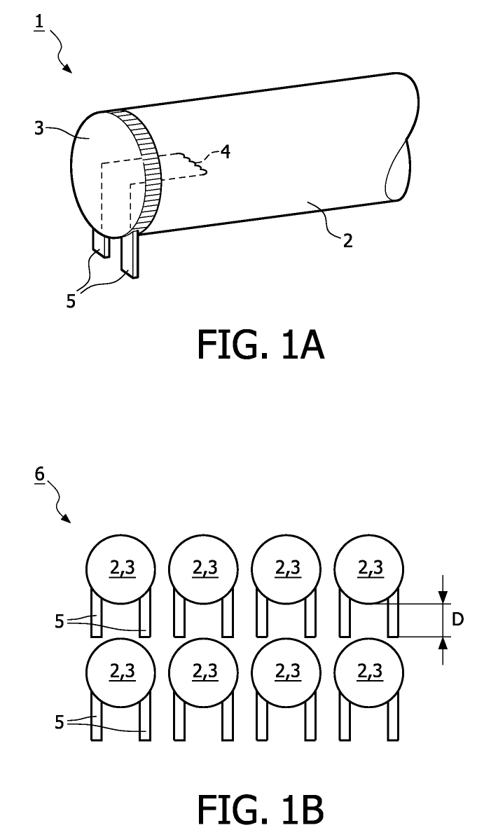

FIG. 1a is a perspective view of part of a lamp known from the prior art,

FIG. 1b is a side elevation of an assembly of lamps according to FIG. 1a in the packed state,

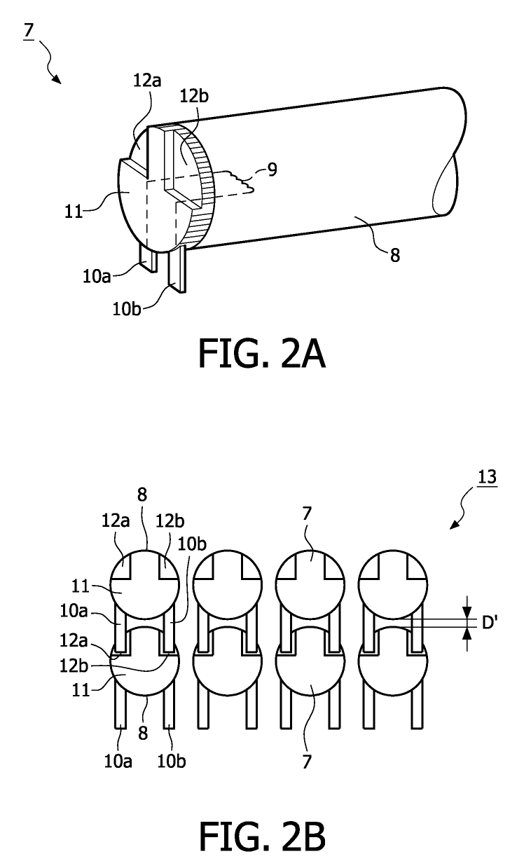

FIG. 2a is a perspective view of part of a lamp according to the invention,

FIG. 2b is a side elevation of an assembly of lamps according to FIG. 2a in the packed state,

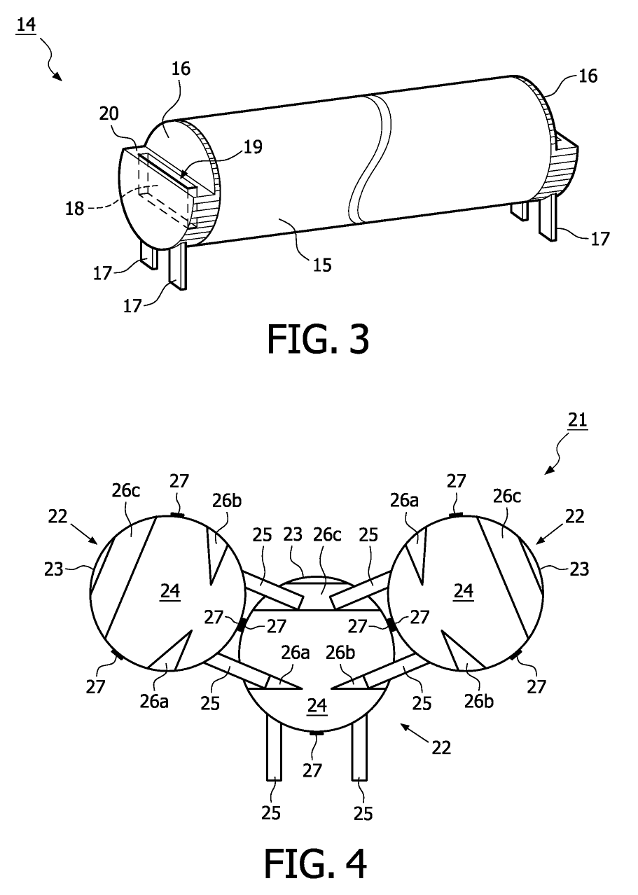

FIG. 3 is a perspective view of an alternative lamp according to the invention, and

FIG. 4 is a side elevation of another assembly of light sources according to the invention.

FIG. 1a is a perspective view of part of a lamp 1 known from the prior art. The lamp 1 comprises a discharge vessel 2 filled with an ionizable substance, at the extreme ends of which vessel 2 two end caps 3 are provided (of which only one end cap 3 is shown in this Figure). The lamp 1 further comprises two electrodes 4 that are connected to opposite sides of the discharge vessel 2. Each electrode 4 is partly embedded in an end cap 3, two contact elements 5 of each electrode 4 extending laterally with respect to the discharge vessel 2 (and the end caps 3), which makes the lamp 1 ideally suitable for backlight purposes.

FIG. 1b is a side elevation of an assembly 6 of eight lamps 1 according to FIG. 1a in the packed state. As can be seen in this Figure, the lamps 1 are packed in a relatively voluminous state due to the laterally extending contact elements 5 of the electrodes 4. The mutual distance D between the discharge vessels 2 is relatively large, since physical contact between the contact elements 5 of an upper lamp 1 and the discharge vessel 2 of a lower lamp 1 must be prevented, which physical contact could easily damage the discharge vessel 2, or at least a (fluorescent) coating applied thereon.

FIG. 2a is a perspective view of part of a lamp 7 according to the invention. The improved lamp 1 comprises a discharge vessel 8 provided with two electrodes 9 (of which only one is shown). Each electrode 9 comprises two contact elements 10a, 10b extending in an outward direction with respect to the discharge vessel 8, said direction being substantially perpendicular to the longitudinal axis of the discharge vessel 8. The outer ends of the discharge vessels 8 are provided with an improved end cap 11 for protecting the discharge vessel 8 and a respective electrode 9 and for allowing the discharge vessel 8 to be mounted (clamped) in an illumination system for illuminating display devices (not shown). Each end cap 11 is provided with two receiving slots 12a, 12b for partly receiving the respective contact elements 11a, 11b of another, similar lamp 7, thus considerably enhancing the packing density of the lamps 7.

FIG. 2b is a side elevation of an assembly 13 of lamps 7 according to FIG. 2a in the packed state. As can be seen in this Figure, the contact elements 10a, 10b of the electrodes 9 of the upper lamps 7 are accommodated partly within the receiving slots 12a, 12b of the lower lamps 7. The packing density of the lamps 7 can thus be significantly increased in that the mutual distance D′ between the discharge vessels 8 of mutually cooperating lamps 7 is significantly reduced. A space saving of about 40 percents can be achieved in this manner, which will also substantially reduce the transportation and storage cost. In the embodiment shown, each contact element 10a, 10b is supported by a bottom surface of a receiving slot 12a, 12b so as to guarantee a certain minimum distance between the discharge vessels 8 of cooperating lamps 7. To increase the energy-absorbing capacity of the assembly 13, the end caps 11, or at least the bottom surfaces of the receiving slots 12a, 12b of the end caps 11, are preferably made of a flexible material, in particular an elastomer. Damage to the assembly 13 due to external impacts can be counteracted thereby.

FIG. 3 is a perspective view of an alternative lamp 14 according to the invention. The lamp 14 comprises an elongate discharge envelope 15. The envelope 15 is enclosed by two end caps 16. Each end cap 16 is adapted for partly accommodating an electrode comprising two contact elements 17. The contact elements 17 here extend transversely to the envelope 15. The end cap is made of rubber and is provided with a cavity 18 for partly receiving portions of the contact elements 17 of another, similar lamp 14. An aperture 19 of the cavity 18 is designed such that a rim 20 defining the aperture 19 will engage the contact elements 17 of another, similar lamp 14 under a bias pressure so as to realize a clamping fit whereby a reliable coupling between the two lamps 14 is achieved.

FIG. 4 is a side elevation of another assembly 21 of light sources 22 according to the invention. Each light source 22 comprises a discharge vessel 23 enclosed by two end caps 24. The discharge vessel 23 is electrically connected to two electrodes, each electrode comprising two contact elements 25 extending laterally with respect to the end cap 24. Each end cap 24 is provided with multiple receiving spaces 26a, 26b, 26c for simultaneously receiving respective portions of the contact elements 25 of multiple light sources 22 so as to achieve a relatively dense packing of light source 22, which is favorable from a logistical point of view. Each end cap 24 is provided with multiple projecting coupling elements 27 for a detachable coupling of neighboring light sources 22, such that the discharge vessels 23 of the individual light sources 22 can be kept at a mutual distance to prevent damage.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The use of the verb “comprise” and its conjugations does not exclude the presence of elements or steps other than those stated in a claim. The article “a” or “an” preceding an element does not exclude the presence of a plurality of such elements. The mere fact that certain measures are recited in mutually different dependent claims does not indicate that a combination of these measures cannot be used to advantage.

1. Light source, comprising:
an at least partly light-transmitting, elongate discharge vessel filled with an ionizable substance,
a first electrode and a second electrode connected to respective end portions of the light source, between which first and second electrodes a discharge extends during lamp operation, at least one electrode of the first electrode and the second electrode extending laterally with respect to the corresponding end portion,
characterized in that at least one end portion is provided with at least one receiving slot for receiving at least a portion of at least one electrode of at least one other, similar light source.

2. Light source according to claim 1, characterized in that each end portion of the light source is connected to an electrode comprising multiple contact elements extending laterally with respect to said end portion.

3. Light source according to one claim 2, characterized in that the at least one receiving slot is adapted for simultaneously receiving multiple contact elements at least partly.

4. Light source according to claim 2 characterized in that the at least one end portion is provided with multiple receiving slots for receiving respective multiple contact elements.

5. Light source according to claim 1, characterized in that each end portion is provided with at least one receiving slot.

6. Light source according to claim 1, characterized in that the discharge vessel is provided with multiple end caps, each end cap defining one of the end portions of the light source.

7. Light source according to claim 6, characterized in that each end cap is provided with at least one laterally projecting element, said projecting element being adapted to cooperate with an end cap of another, similar light source for substantially spacing apart the discharge vessels of the two light sources.

8. Light source according to claim 7, characterized in that the projecting element is adapted to be detachably coupled to an end cap of another, similar light source.

9. Light source according to claim 6, characterized in that at least a portion of each end cap is made of a flexible material, in particular an elastomer.

10. Light source according to claim 1, characterized in that each receiving slot is adapted to engage an electrode of another, similar light source with clamping fit.

11. Light source according to claim 1, characterized in that each receiving slot is adapted for substantially enclosing an outwardly extending portion of an electrode of another, similar light source.

12. Assembly of multiple light sources according to claim 1, wherein the electrodes of each light source are partly received by the receiving slots of a neighboring light source.

13. Assembly according to claim 12, characterized in that the assembly of light sources is oriented substantially linearly.

14. Assembly according to claim 12, characterized in that the assembly of light sources is oriented substantially non-linearly.
